(19) United States
(12) Patent Application Publication
(10) Pub. No.: US 2017/0017508 A1
(43) Pub. Date: Jan. 19, 2017

(54) METHOD FOR FORMING A VIRTUAL ENVIRONMENT IN AN OPERATING SYSTEM OF A COMPUTER

(71) Applicant: BACKES SRT GMBH, Saarbrucken (DE)

(72) Inventor: Philipp VON STYP-REKOWSKY, Saarbrucken (DE)

(21) Appl. No.: 15/212,459

(22) Filed: Jul. 18, 2016

(30) Foreign Application Priority Data
Jul. 17, 2015 (DE) 10 2015 111 625.1

(51) Int. Cl. G06F 9/455

(52) U.S. Cl. CPC G06F 9/45508

(57) ABSTRACT

A method for forming a virtual environment in an operating system of a computer, particularly in the “Android” operating system, wherein the operating system is provided for the purpose of providing, for each piece of application software executed under the operating system, a separate area that is isolated from the respective areas for other application software. The virtual environment is formed by a virtualization program that is executed in one of the separate areas of the operating system, and an application program is executed in the virtualization program in a manner partially or completely isolated from the operating system.

### CROSS-REFERENCE TO RELATED APPLICATIONS

The present application claims priority of DE 10 2015 111 625.1, filed Jul. 17, 2015, the priority of this application is hereby claimed and this application is incorporated herein by reference.

### BACKGROUND OF THE INVENTION

The invention relates to a method for forming a virtual environment in an operating system of a computer, particularly in the “Android” operating system, wherein the operating system is provided for the purpose of providing, for each piece of application software executable under the operating system, a separate area that is isolated from the respective areas for other application software.

The invention further relates to a computer program product that can be loaded directly into an internal memory of a digital computer and comprises software sections that are used to perform the steps of the method when the computer program product runs on a computer, and to an apparatus for data processing that comprises means for performing the method.

The “Android” operating system is an operating system for mobile devices such as smart phones, mobile telephones, tablet computers and the like that has a Linux kernel, which is responsible for memory and process management, and forms an interface for network communication and for reproducing multimedia and the network communication and also a hardware abstraction layer for software and device drivers for the operating system.

While, in conventional desktop operating systems such as Microsoft Windows, Linux or the like, a common data area is formed in which different application software is stored and executed and in which communication with the operating system is regulated on the basis of the respective rights of a user, the “Android” operating system involves, for each piece of application software, dedicated separate areas being formed in which data and code execution are isolated from other application software. To this end, the “Android” operating system assigns each piece of application software a unique user identity (UID) during installation, which user identity is taken as a basis by components of the operating system for performing access control for the respective application software, and under which user identity said application software can communicate in the operating system. The application software is allocated access and/or action rights in the operating system that are checked by means of a Linux kernel of the operating system. Furthermore, data from the application software are normally readable only for the application itself. In order to allow access to the data by another piece of application software, the latter needs to be specifically set up therefor. In the “Android” operating system, an access mechanism is provided therefor that the respective application software can access when set up as appropriate.

Therefore, certain difficulties arise for the creation of software that can be used to find, block, isolate and remove malware such as computer viruses in the “Android” operating system.

The conventional virus scanners for the desktop operating systems can perform their functions by, inter alia, accessing information from the desktop operating system directly for monitoring purposes, normally equipped with administrator rights, and manipulating the desktop operating system directly in order to prevent actions via the malware. In the absence of the common data area for the application software in the “Android” operating system, however, the virus scanners cannot be designed in the same way as for the desktop operating systems.

Although virus scanners are available for the “Android” operating system, they can only identify and report the installations of application software, but cannot regulate actions by already installed application software.

A method, known from use, for improving the security of the “Android” operating system involves the application software being modified, when it is installed, by adding program code in order to be able to better control its communication. However, this often results in the problem that the application software works to a poorer degree or only to a limited extent.

Further methods, known through use, involve the operating system itself being modified (“rooting” in the case of Android, “jail-break” in the case of iOS). However, modification of the operating system requires certain knowledge and cannot readily be performed by an untrained user. Furthermore, legal problems can arise, for example as regards a warranty offered by a manufacturer of a device provided with the operating system.

### SUMMARY OF THE INVENTION

The invention is based on the object of providing a method of the type cited at the outset that can be used, with simple handling, to increase the security of the operating system against undesirable actions by the application program.

According to the invention, this object is achieved by virtue of the virtual environment being formed by a virtualization program that is executable in one of the separate areas of the operating system and in which an application program is executed in a manner partially or completely isolated from the operating system.

With regard to the computer program product, the object is achieved by virtue of the virtual environment being formed by a virtualization program that is provided so as to be executed in one of the separate areas of the operating system and is set up such that an application program can be executed therein in a manner partially or completely isolated from the operating system.

The invention can prevent direct access by the application program to the operating system. The opportunity is provided for the virtualization program to monitor and regulate the application program, particularly its access to information and its communication. To this end, the virtualization program expediently forms a control interface between the application program and the operating system.

In order to ensure that the application program cannot act in an uncontrolled manner, the virtualization program is embodied such that communication by the application program with the operating system can be effected exclusively via the virtualization program. Expediently, the application program can run in the virtualization program without any direct access to the kernel of the operating system, particularly without access to the middleware of the operating system and without the ability to make lasting changes in the file system.

Undesirable actions such as forwarding of information or the spread of viruses by the application program can be prevented thereby. Since the application programs, particularly under the “Android” operating system, are closely involved in the middleware of the operating system, e.g. for life cycle management or for intercomponent communication, the virtualization program can permit the proceeding communication gradually and in a controlled manner in order to link the isolated application program to the operating system.

The virtualization program is expediently formed such that it is installable and executable in the operating system in the same way as conventional application software. On installation, it is preferably provided with a user identity (UID) under which it can communicate in the operating system, which is assigned action and/or data access rights in the operating system and under which data are stored.

The virtual environment formed by the virtualization program is designed, in the preferred embodiment of the invention, such that the application program can be installed and handled therein in the same way as if it were compiled directly in the operating system.

Advantageously, formation of the virtual environment requires neither the operating system nor the application program to be changed, which means that it can be installed and used in the same way as conventional application programs. Special knowledge is not required for installation of the application program and handling thereof.

In a preferred embodiment of the invention, the virtualization program is provided such that various application programs can be executed and controlled therein simultaneously, so that an isolated and secure area can be provided for the application programs in the operating system. Each of the application programs is provided with a user identity (UID) of its own that the virtualization program can use to associate the respective communication. The virtualization program communicates with the operating system only under its own user identity, however.

Furthermore, two or more of the virtualization programs can be provided in the operating system and, if need be, executed simultaneously in order to provide separate application program areas, e.g. for forming a business area and a private area, on the respective computer provided with an operating system.

Expediently, the virtualization program is provided such that following respective reinstallation of an added application program under the virtualization program, communication or at least parts of the communication by the added application program with the operating system is or are blocked.

Preferably, there is provision for the virtualization program to permit the communication of each application program selectively for particular functions or function areas, the functions or function areas being able to be associated according to respectively required data access operations beforehand. To this end, a graphical user interface (GUI) is preferably provided for the virtualization program, said graphical user interface providing an option to set rights for the application program for communication for the functions or function areas.

In a refinement of the invention, the virtualization program is set up to provide, for each application program running in it, a dedicated environment device that forms, for the application program, an application environment that is conventionally provided by the operating system for the application program, the application program preferably being able to be loaded and executed dynamically in the environment device.

Expediently, the virtualization program further has a regulatory device that is provided for the purpose of monitoring an input/output mode and regulating, particularly permitting or blocking, it on the basis of the respective setting of the communication rights. The input/output mode can comprise a system call (Syscall), e.g. in order to access the file system, network sockets, Bluetooth and other low-level resources, or to gain access to a connecting module of a kernel module of the operating system, e.g. the linker module of the Linux kernel of the “Android” operating system, for example in order to communicate with the middleware of the operating system.

In a particularly preferred embodiment of the invention, the environment device forms an isolated process that is provided for use in the “Android” operating system. This process has been provided under the “Android” operating system so that program developers can permit particular components of an application program to run in isolation from the remainder of the operating system, in order to allocate only restricted or no access or action rights to the components. This makes it possible to prevent security gaps from being exploited when processing content from unfamiliar sources. According to the invention, the isolated process is preferably used to accommodate a complete application program.

The virtualization program further provides, for the purpose of accommodating each application program that is intended to run under it, an interface for interprocess communication (“IPC interface”) that the environment device and the regulatory device can use to communicate. The regulatory device can use the IPC interface to preferably initialize and terminate the environment device by means of a preparation function (“prepare”) and a termination function (“terminate”).

The virtualization program expediently further forms a device for receiving and forwarding communication between the application program and the middleware of the operating system. The device changes the communication such that it is sent not directly to the connecting module of the kernel but rather to the regulatory device, with preferably handles for communication with the connecting module being overwritten.

The virtualization program further comprises a device for receiving and forwarding the system call that originates from the application program running in the environment device. The reception and forwarding device is provided for the purpose of diverting the system call, which is originally directed to the operating system, to the regulatory device, the system call preferably being changed such that a function of the regulatory device is called instead of that function of the operating system that is inherently provided for retrieval. Conversely, the reception and forwarding device is also provided so as to relay a response, returned by the regulatory device following the system call, to the environment device and hence the application program.

The regulatory device is provided, in the preferred embodiment of the invention, for the purpose of regulating the input/output mode for various functions of the application program separately, the functions being selectable, preferably individually and/or in groups.

In a refinement of the invention, the regulatory device has a first layer that is provided for the purpose of receiving and semantically adjusting the system call and also the communication to the connecting module or middleware from the environment device or the reception and forwarding devices and of transmitting them to a second layer, in which a check is performed to determine whether the system call or the communication is admissible and accordingly is forwarded or blocked. In cases in which the system call or the communication is blocked, the second layer produces responses appropriate to the respective system call or to the communication, which responses allow the application program to continue to operate. Furthermore, communication that is directed to another application program running under the virtualization program is processed without accessing the operating system by virtue of the virtualization program being prompted to itself access respectively required information or to perform or prompt requested actions. The communication to the most recently cited other application program cannot be performed by the operating system, since it runs under the virtualization program and is therefore not known to the operating system.

A third layer of the regulatory device is expediently provided for the purpose of making the communication that originates from the application program appear to the operating system as communication by the virtualization program and, conversely, of associating communication directed from the operating system to the application program, provided that multiple application programs run under the virtualization program, with the respective application program. To this end, identifiers from components of the application program are preferably replaced by components of the virtualization program.

In a further refinement of the invention, the virtualization program has at least one standard program preinstalled in it as an application program, said standard program usually being provided in the operating system and being able to be a contact data program, a calendar program, a camera program, an SMS program or a telephone program, for example. Provided that one of the application programs attempts to use the operating system to access the standard program, the regulatory device can divert the relevant communication to the standard program provided under the virtualization program. Uncontrolled access to the standard program that can be reached via the operating system can thus be prevented.

Alternatively or additionally, the virtualization program may be provided for the purpose of executing said standard program in the virtualization program and setting it up such that a dedicated database is formed for the standard program when it runs under the virtualization program, which database differs from the one that the standard program accesses when it runs under the operating system. When the application program accesses the standard program that can be reached under the operating system, it is routed by the regulatory device to the standard program running under the virtualization program, and therefore it has access only to the database provided under the virtualization program. The virtualization program is expediently set up such that the standard program can run under the operating system and under the virtualization program simultaneously.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 shows an apparatus based on the prior art,

FIG. 2 shows an apparatus according to the invention, and

FIG. 3 shows details of the apparatus shown in FIG. 2.

### DETAILED DESCRIPTION OF THE INVENTION

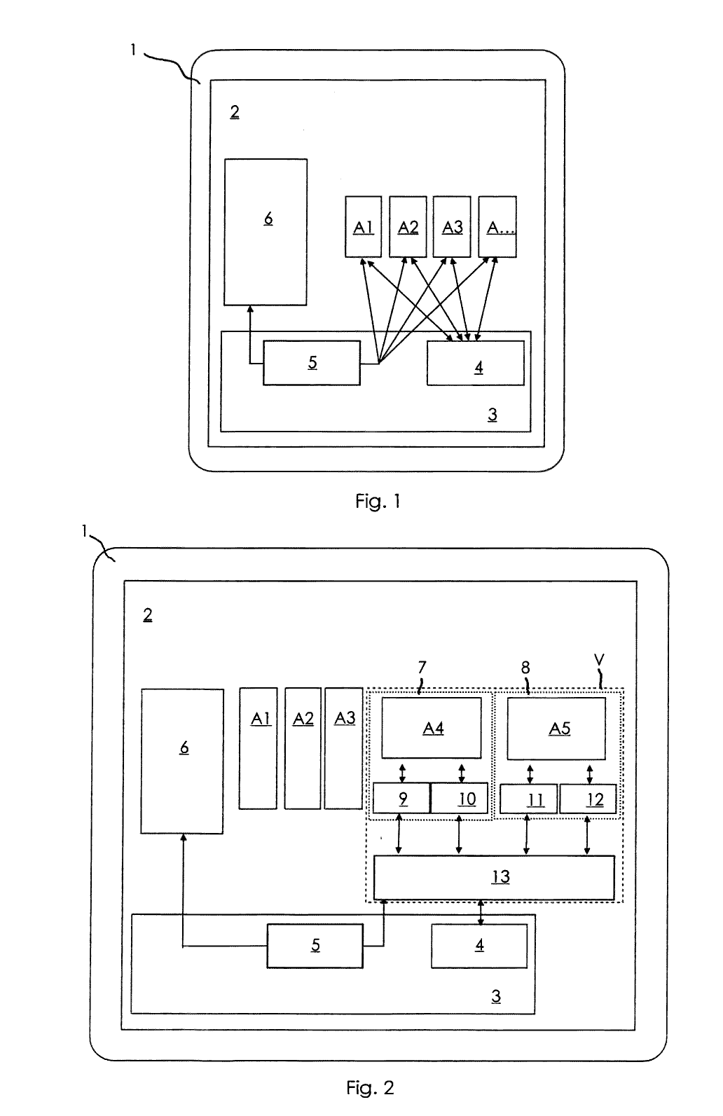

FIG. 1 shows a computer 1, for example a smart phone, that is operated in a known manner using the “Android” operating system 2 described at the outset. The operating system 2 comprises a Linux kernel 3, which has a device 4 for performing system calls (“Syscalls”) and a connecting module 5 (“Linker module”) for performing communication with a piece of middleware 6 that uses a device for communication between applications (“Inter-Process Communication”, IPC for short) for communication. Multiple application programs A1, A2, A3 run under the operating system 2, with separate environments being formed for each of the application programs A1, A2, A3 in the operating system 2, in which environments the respective data from the application programs A1, A2, A3 and also implementation of the program code of the application programs A1, A2, A3 are isolated from one another. The operating system 2 allocates to each of the application programs A1, A2, A3, during installation, a unique user identity (UID), which is taken as a basis by the respective application program A1, A2, A3 for handling access and action rights in the operating system 2 and particularly also storing data. To this end, the kernel 3 performs access control, in particular discretionary access control (DAC) and mandatory access control (MAC), for the system calls. Access operations by the connecting module 5 to the middleware 6 are monitored by means of a monitor device that checks and implements access and action rights compliant with the respective user identity.

The method according to the invention is explained below on the basis of FIG. 2.

The operating system (“Android”) 2 has a virtualization program V according to the invention installed under it that the operating system 2 treats as one of the conventional application programs A1, A2, A3 and for which, accordingly, one of the cited separate environments is formed in the operating system 2. The virtualization program V is set up to accommodate multiple application programs A4, A5 such that they can run therein simultaneously.

The virtualization program V is provided with a user identity (UID) of its own, under which it runs in the operating system 2 and which has been allocated almost all of the access rights or just merely slightly restricted access rights to the operating system 2.

All communication by the virtualization program V with the operating system 2 takes place under the user identity of the virtualization program V. By contrast, user identities associated with the application programs A4, A5 remain unknown to the operating system 2, which means that all communication by the application programs A4, A5 appears to the operating system 2 as communication by the virtualization program V.

For each of the application programs, the virtualization program V provides an environment device 7, 8 that forms, for each of the application programs A4, A5, one of the aforementioned isolated processes provided in the “Android” operating system 2, in which process the respective application program A4, A5 can run.

Further, the virtualization program V comprises a regulatory device 13 that the environment device 7 uses to communicate with the kernel 3 and that is provided for the purpose of checking the communication between the application program A4, A5 and the kernel 3 and, depending on a result of the check, forwarding or blocking the communication.

To use the application programs A4, A5, the virtualization program V prompts provision of the respective environment device 7, 8 and provides devices 9, 10, 11, 12 for routing the communication by the application programs A4, A5 with the kernel 3.

The respective routing device 9, 11 is provided for the purpose of altering communication proceeding between the application programs A4, A5 and the connecting module 5 or the middleware 6 via said device for IPC such that it is performed via the regulatory device 10. To this end, references in the memory of the respective application program A4, A5 that are directed to components of the operating system 2 are altered such that they are directed to the regulatory device 10, with e.g. handles for communication with the connecting module 5 being overwritten.

The routing device 10, 12 can be used to route the system calls (Syscalls) of the application programs A4, A5 to the regulatory device 13. To this end, program code addresses in a memory assigned to the application program A4, A5 are changed and, as a result, a function of the regulatory device 13 is called instead of that function of the operating system 2 that is inherently provided by the respective system call for retrieval. The regulatory device 13 checks the system call and, provided that it is permitted, relays it to the operating system 2.

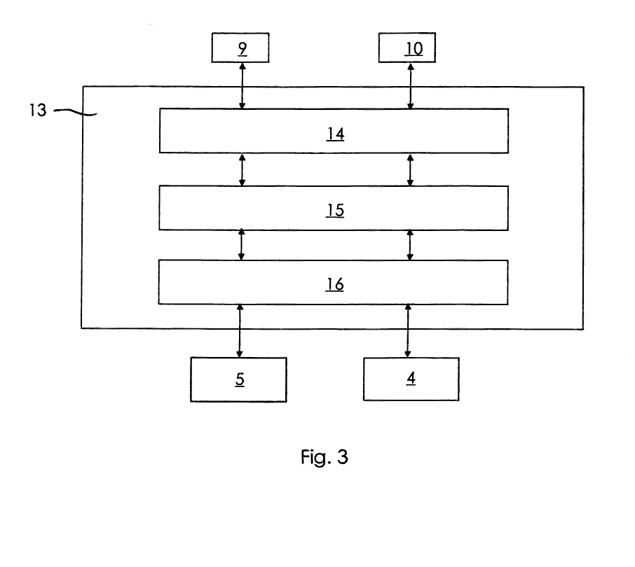

As is evident from FIG. 3, the regulatory device 13 has three layers 14, 15, 16. The layer 14 is provided for the purpose of receiving the communication from the environment device 7, 8, i.e. the system calls and the communication directed to the middleware 6, and of sending communication originating from the operating system 2 to the environment device 7, 8.

In the layer 15, the communication is checked, wherein the communication, provided that it is admissible, is forwarded to the layer 14 for further processing by one of the application programs A4, A5 or to the layer 16 for further processing by the operating system 2.

Further, in the event of inadmissible communication that needs to be blocked by the regulatory device 13, the layer 15 produces a response appropriate to the blocked communication so that the application program A4, A5 can continue to be executed in the midst of processing of the response.

Further, the layer 15 is set up to handle requests by one of the application programs A4, A5 that relate to the other application program A4, A5 autonomously. Since the operating system 2 does not know the application programs A4, A5, it cannot deal with the corresponding communication. The layer 15 identifies such communication and, in order to process it, undertakes the functions that the operating system 2 would normally perform and forms links that are necessary for the communication.

The layer 16 is provided for the purpose of receiving the communication originating from the operating system 2 and associating it with the respective application program A4, A5 to which it relates and relaying it to the layer 15, and of modifying the communication originating from the application program A4, A5 such that, to the operating system 2, it appears as communication by the virtualization program V.

The operation of the virtualization program is described in specific terms below on the basis of an instant messenger application program with reference to FIG. 2.

The instant messenger application program is formed by the application program A4 that runs under the virtualization program V. Further, a contact data program runs under the virtualization program V as the application program A5.

Further, said separate areas have a browser, as the application program A1, and a contact data program, originally preinstalled with the operating system 2, as the application program A2, installed in them.

The instant messenger application program A4 is provided for the purpose of using the Internet to send messages to third parties that likewise use the instant messenger application program A4 and of disclosing a current location of the computer 1 on which the instant messenger application program A4 runs. Further, Internet links received via the instant messenger application program A4 can be opened in the browser A1 directly from the instant messenger application program A4. Further, the instant messenger application program A4 is provided for the purpose of accessing the originally installed contact database A2.

Immediately after installation of the instant messenger program A4 under the virtualization program V, the regulatory device 13 is preset such that all communication and system calls by the instant messenger program A4 are blocked. A user of the computer 1 uses a GUI of the virtualization program V to make settings according to which Internet access and access to the browser A1 are admissible. By contrast, access to the current location of the computer 1 and access to the preinstalled contact data program A2 remain blocked.

In order to access the Internet and to be able to send messages to third parties, the instant messenger application program A4 sends a system call that is relayed by the regulatory device 13 on the kernel 3 and a device 4 for performing system calls, so that a network socket can be set up that the instant messenger application program A4 uses for communication via the Internet.

When an Internet link is received by means of the instant messenger application program A4, the regulatory device 13 routes the relevant communication via the connecting module 5 of the kernel 3 to the middleware 6 and from there to the browser A1, in which the web page that is callable under the Internet link is then opened.

If the instant messenger application program A4 attempts to access the current location of the computer 1, the regulatory device 13 blocks the relevant system call and returns a previously stipulated or a randomly selected location to the instant messenger application program A4.

Provided that the instant messenger application program A4 attempts to access the contact data program A2, the regulatory device 13 diverts the relevant communication to the contact data program A5 running under the virtualization program V.

The contact data program A5 may be the same application program as the contact data program A2 preinstalled under the operating system 2. One difference is then merely that the contact data program is executed under the virtualization program V or the operating system 2 and can access various databases. It is possible for the contact data program A2 to be executed under the operating system 2 the contact data program A5 to be executed under the virtualization program V simultaneously. However, it is also conceivable for the contact data program A5 to differ from the contact data program A2.

While specific embodiments of the invention have been shown and described in detail to illustrate the inventive principles, it will be understood that the invention may be embodied otherwise without departing from such principles.

I claim:

1. A method for forming a virtual environment in an operating system of a computer, particularly in the “Android” operating system, comprising the steps of: providing, via the operating system, for each piece of application software executed under the operating system, a separate area that is isolated from respective areas for other application software; forming the virtual environment by executing a virtualization program in one of the separate areas of the operating system; and executing an application program in the virtualization program in a manner at least partially isolated from the operating system.

2. The method according to claim 1, wherein various application programs run simultaneously in the virtualization program.

3. The method according to claim 1, wherein the virtualization program monitors and regulates communication between the application program and the operating system.

4. The method according to claim 3, wherein the virtualization program permits or blocks communication between the application program and the operating system.

5. The method according to claim 1, wherein the virtualization program forms, for each application program running in it, an environment device, under which the application program is executed, and a regulatory device, which monitors and regulates the communication of the application program running in the environment device.

6. The method according to claim 5, wherein the regulatory device regulates an input/output mode of the application program running in the environment device.

7. The method according to claim 5, wherein the environment device is provided for receiving and forwarding a system call and/or communication between the application program and the operating system.

8. The method according to claim 7, wherein the environment device receives and forwards a system call and/or communication between the application program and a piece of middleware of the operating system.

9. The method according to claim 5, wherein the regulatory device regulates the communication for various functions of the application program separately, the functions being selected individually and/or in groups.

10. The method according to claim 5, wherein execution of multiple application programs prompts the regulatory device to regulate the communication for each of the execution programs separately.

11. The method according to claim 10, wherein the regulatory device alters the communication originating from the environment device so that, to the operating system, the communication appears as communication by the virtualization program, and alters communication originating from the operating system such that the communication can be associated with the respective application program to which the communication relates.

12. The method according to claim 5, wherein the regulatory device is set up to process communication that is directed to further application programs running under the virtualization program without accessing the operating system.

13. A computer program product that can be loaded directly into an internal memory of a digital computer and comprises software sections that perform the method steps according to claim 1 when the computer program product runs on a computer.

14. An apparatus for data processing, comprising means for performing the virtualization method according to claim 1.
